(19) United States
(12) Patent Application Publication
(10) Pub. No.: US 2016/0125023 A1
(43) Pub. Date: May 5, 2016

(54) DERIVED TABLE JOIN PROCESSING

(71) Applicants: James M. Plasek, Roseville, MN (US); Jennifer J. Smith, Roseville, MN (US)

(72) Inventors: James M. Plasek, Roseville, MN (US); Jennifer J. Smith, Roseville, MN (US)

(73) Assignee: UNISYS CORPORATION, Blue Bell, PA (US)

(21) Appl. No.: 14/533,267

(22) Filed: Nov. 5, 2014

(51) Int. Cl. G06F 17/30

(52) U.S. Cl. CPC G06F 17/30383; G06F 17/30339; G06F 17/3033; G06F 17/30498

(57) ABSTRACT

Systems and methods for processing tables for query operations referencing the tables are described. A method may include determining whether a table is referenced one time or more than one time in a query that includes at least one operation referencing the table. The method may further include creating a single materialized view of the table when the table is determined to be referenced more than one time in the query. The method may also include creating two or more hash tables based, at least in part, on the single materialized view of the table by creating a hash table for each operator in the query that references the table, and evaluating the query using the two or more hash tables.

### FIELD OF THE DISCLOSURE

The instant disclosure relates generally to the processing of tables for query operations. More specifically, this disclosure relates to derived table join processing in database management systems.

### BACKGROUND

Analytic queries often reference database tables in which data necessary to evaluate the queries may be found. A table referenced in a query is typically referred to as a relation, and in general, a relation is a set of tuples, also referred to as records. Many operations that utilize relations can be found in queries, such as the JOIN or UNION operations which combine records from two or more tables in a database. For example, the JOIN operator can be used to combine relations r1 and r2 based on common field (column) values. The relation may be a table which persists in a database or it may be materialized when needed, such as when a view, derived table, or a common table expression (CTE) is referenced.

The processing of operations that reference relations has become a significant bottleneck limiting the performance of conventional database management systems. For example, in conventional database management systems, a table is materialized each time the relation is referenced, so if the relation is referenced more than once within a query, then the table will also be materialized more than once for the query. In addition, when a relation is joined, but there is no index upon which to join, a hash table is created for a materialized view of the relation (table). Therefore, as each JOIN operation is encountered in the query, the referenced table is materialized, and a hash table for the relation is created. The redundant materialization of tables and creation of hash tables wastes significant time and resources. In addition, if the size of the table being referenced is large, significant input/output (1/O) resources may be consumed because the large table must be accessed from a database and materialized.

### SUMMARY

The performance of database management systems processing tables for query operations that reference the tables may be improved by detecting, during the optimization processing performed on the query before the query gets evaluated, whether or not a relation is referenced multiple times in the query, then using that information to determine whether or not the relation should be materialized. The query analyzer/optimizer may then build an instruction set to be used by a runtime processor component to eliminate multiple passes through a materialized derived table/CTE set of records. As a result, a materialized relation may be referenced only once, which may yield better computer system performance by reducing query execution time and reducing the amount of resources necessary to execute/evaluate the query.

According to one embodiment, a method for processing tables for query operations referencing the tables may include determining whether a table is referenced one time or more than one time in a query that includes at least one operation referencing the table. The method may also include creating a single materialized view of the table when the table is determined to be referenced more than one time in the query. The method may further include creating two or more hash tables based, at least in part, on the single materialized view of the table by creating a hash table for each operator in the query that references the table. The method may also include evaluating the query using the two or more hash tables.

According to another embodiment, a computer program product may include a non-transitory computer-readable medium comprising code to perform the step of determining whether a table is referenced one time or more than one time in a query that includes at least one operation referencing the table. The medium may also be configured to perform the step of creating a single materialized view of the table when the table is determined to be referenced more than one time in the query. The medium may further be configured to perform the step of creating two or more hash tables based, at least in part, on the single materialized view of the table by creating a hash table for each operator in the query that references the table. The medium may also be configured to perform the step of evaluating the query using the two or more hash tables.

According to yet another embodiment, an apparatus may include a memory and a processor coupled to the memory. The processor may be configured to execute the step of determining whether a table is referenced one time or more than one time in a query that includes at least one operation referencing the table. The processor may also be configured to execute the step of creating a single materialized view of the table when the table is determined to be referenced more than one time in the query. The processor may be further configured to execute the step of creating two or more hash tables based, at least in part, on the single materialized view of the table by creating a hash table for each operator in the query that references the table. The processor may also be configured to execute the step of evaluating the query using the two or more hash tables.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the concepts and specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed systems and methods, reference is now made to the following descriptions taken in conjunction with the accompanying drawings.

FIG. 1 is a schematic block diagram illustrating a first embodiment of a computing system including a database management system according to one embodiment of the disclosure.

FIG. 2 is a schematic block diagram illustrating a second embodiment of a computing system including a database management system according to one embodiment of the disclosure.

FIG. 3 is a schematic view illustrating a user application interface to a database management system and the modules of the data management system that perform processing of tables for query operations referencing the tables at the database management system according to one embodiment of the disclosure.

FIG. 4 is a flow chart illustrating a method for processing tables for query operations referencing the tables according to one embodiment of the disclosure.

FIG. 5 provides an illustration of an instruction set invoked when a table, such as a derived table or CTE, is referenced and subsequently materialized according to one embodiment of the disclosure.

FIG. 6 is a block diagram illustrating a computer network according to one embodiment of the disclosure.

FIG. 7 is a block diagram illustrating a computer system according to one embodiment of the disclosure.

FIG. 8A is a block diagram illustrating a server hosting an emulated software environment for virtualization according to one embodiment of the disclosure.

FIG. 8B is a block diagram illustrating a server hosting an emulated hardware environment according to one embodiment of the disclosure.

### DETAILED DESCRIPTION

The performance of database management systems processing tables for query operations that reference the tables may be improved by detecting, during the optimization processing performed on the query before the query gets evaluated, whether or not a relation is referenced multiple times in the query, then using that information to determine whether or not the relation should be materialized. Additionally, an instruction set to be used by a runtime processor component may be built to eliminate multiple passes through a materialized derived table/CTE set of records.

Database management systems allow for the management of data in a particular database, and for managing access to that data by many different user programs. The user programs may be written in a high level language, such as C, C++, Java, or some other analogous language. In some embodiments, the user program may perform a call to the database management system when a database operation is to be performed.

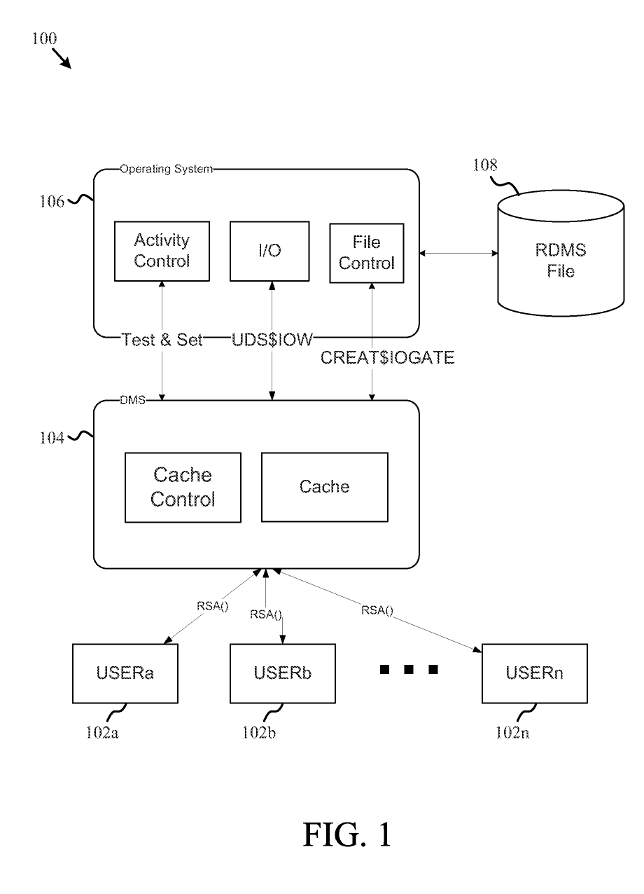

FIG. 1 illustrates a system 100 for processing tables for query operations referencing the tables in a computing system according to one embodiment of the disclosure. When a database management system receives a request to perform a database operation, it may handle the request as depicted in FIG. 1. As illustrated in FIG. 1, a system 100 may include a plurality of user applications 102a-n, from one or more of which a query statement may be received by a database management system 104. If the database management system 104 is a relational database management system the query statement can be, for example, a SQL statement. The database management system 104 may analyze the query statement to determine if there are any errors in the statement itself. Assuming that there are no errors, the database management system 104 may transmit a call to an operating system 106 hosting that system (shown as CREAT$IOGATE), requesting access to the database file 108. The operating system 106 may then assign the database file to the database management system 104. The database management system 104 then caches at least portions of the database file using subsequent system calls (e.g., UDS$IOW). This requested data may be modified by the database management system 104, and control may be returned to the user program for continued execution.

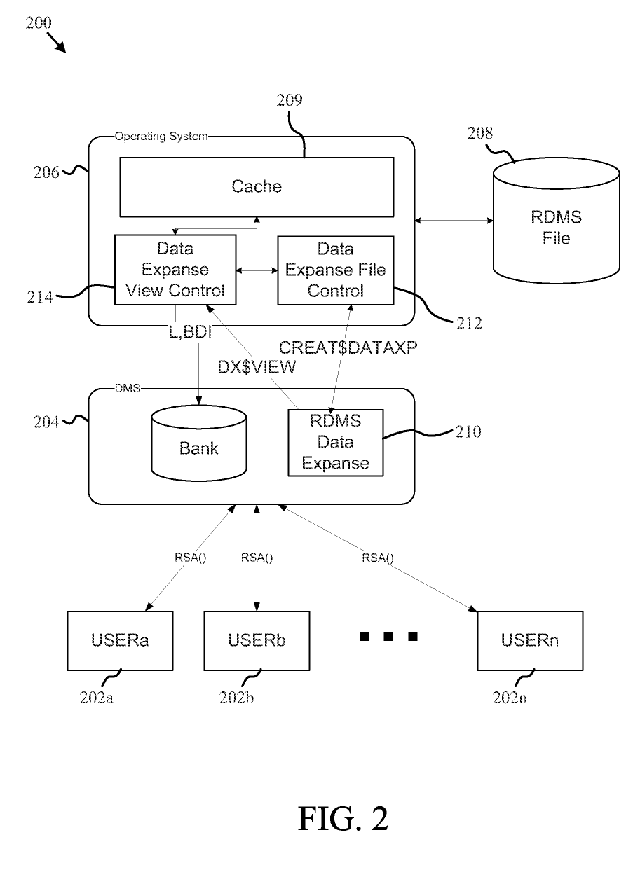

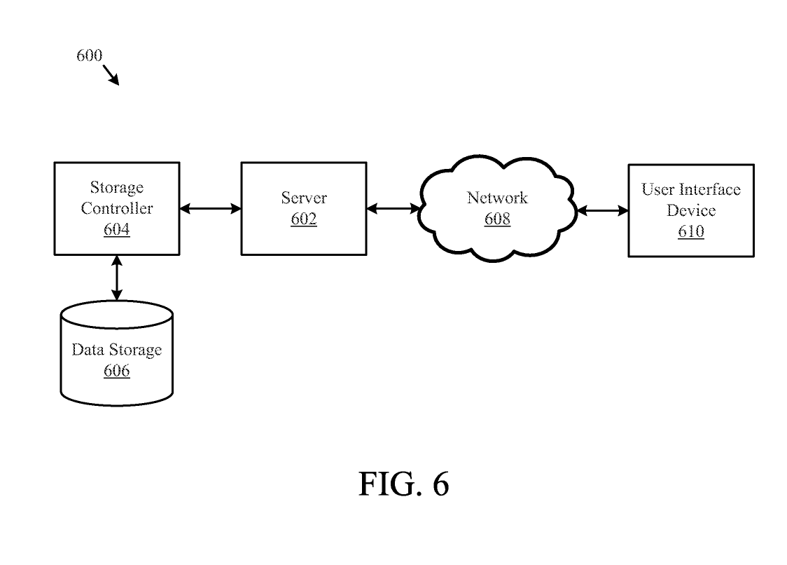

FIG. 2 illustrates a second embodiment of a computing system 200 including a database management system. As shown, the system 200 may include a plurality of user applications 202a-n communicatively coupled to a database management system 204. The user applications 202a-n can be located, for example, on the same computing device as the database management system 204, or on a different computing device or devices that are communicatively connected thereto. Examples of computing devices useable to execute computing instructions constituting the user applications 202a-n and the database management system 204 are discussed below in connection with FIGS. 6-8.

In the embodiment shown in FIG. 2, the database management system 204 may be a relational database management system configured to receive and process SQL commands to perform operations on database files. As illustrated herein, the database management system 204 may be hosted by an operating system 206, which provides access to one or more database files 208. The database management system 204 can be, for example, a possible embodiment of a database management program 104 of FIG. 1.

The operating system 206 can be any of a variety of operating systems capable of hosting a database management system 204 and which provides access controls to data stored in database files 208 on the computing system. In one example embodiment, the operating system 206 can be the OS2200 operating system, from Unisys Corporation of Blue Bell, Pa. In alternative embodiments, other operating systems could be used as well.

In the embodiment shown in FIG. 2, the database management system 204 includes a data expanse viewer 210. The data expanse viewer manages access requests for data stored in various data expanses that are managed by the operating system 206. Cooperatively, the operating system includes a data expanse file control component 212 and a data expanse view control component 214. In some embodiments, the data expanse viewer 210 can transmit a request to the operating system 206, in the form of a call to the data expanse file control component 212 to create a data expanse defined by the attributes of a database file (shown as the call CREAT$DATAXP). This call may tell the operating system 206 to create a cache 209 for the data expanse and initialize all necessary control structures and bit maps to page the cache. Once the data expanse is initialized, the database management system 204 may be returned the address call-back into the operating system to access the data expanse. The data expanse file control component 212 can then load a data file 208 into a cache 209 in the operating system, and return to the data expanse viewer a public starting address of the data expanse that is created.

Following creation of the data expanse, the data expanse viewer 210 can be used by any of the user applications 202a-n to access data in the data expanse. For example, each of the user applications can request a different view of the data expanse, defined by a starting address (i.e., an offset from the starting address returned to the data expanse viewer 210, or an absolute address), as well as a size of the view to be created. This can be accomplished, for example as shown, using the operating system call DX$VIEW, providing the starting address and size of the view to be created. The data expanse view control component 214 can then create a view of the data expanse, and provide to the database management system 204 a private address of the view to be created. For example, the address can be an extended virtual mode address, including a length and a bank descriptor index to reference the location of the view.

In some embodiments, the data expanse may be referenced by its starting address or by an address of a particular segment, therefore the data expanse viewer 210 and other portions of the database management system may not need to be capable of addressing the entire range of the data expanse created. Rather, the particular view created within the data expanse may be fully addressable by the database management system 204. In this way, a database management system, such as system 204, can be made compatible with data files having sizes greater than a maximum addressable range of the database management system. For example, in some embodiments of the present disclosure, the database management system 204 may be capable of individually addressing addresses in a bank of 262 k words; in such an arrangement, the database file 208 can have a size in excess of that number, since the address identified by the database management system to the operating system 206 might identify an offset on a bank-by-bank basis, rather than on an individual, word-addressable basis.

Furthermore, using the system 200 as illustrated, a bank may be made accessible to the database management system 204 without requiring that the database management system cache each database file; this allows the operating system 206 to maintain cache management, which can be performed more efficiently when managed at the operating system level. Still further, and in contrast to locking a bank (and corresponding database file) to a particular application, the data expanse arrangement of FIG. 2 may allow a database file to be individually accessed by many different user applications 202a-n concurrently. By providing a private view into a publicly accessible database file the database management system 204 and operating system 206 may alleviate many possible data conflicts.

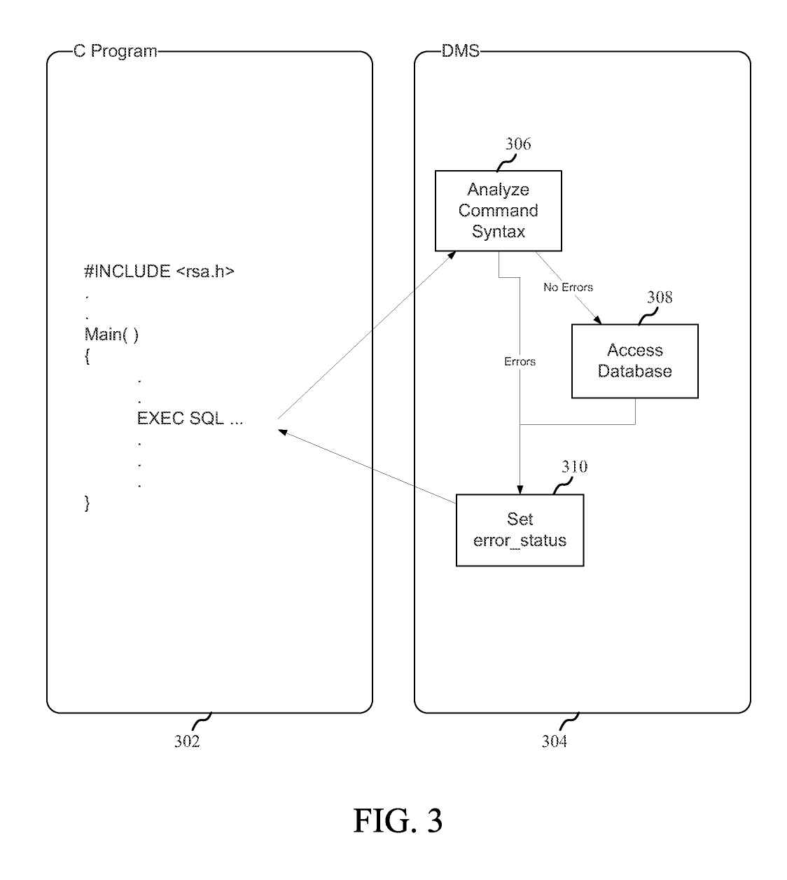

FIG. 3 illustrates a user application interface to a database management system and the modules of the data management system that perform processing of tables for query operations referencing the tables at the database management system according to one embodiment of the disclosure. In the embodiment shown, a user application 302 includes code, which can be written, for example, in C (as shown), or any of a variety of other types of programming languages, such as C++, Java, or other languages. The user application 302 may include a call to a database management program 304 within the code of the application, to effect access to a database, e.g., to read or edit data in the database managed by the database management program 304. In the example embodiment shown, the user application 302 includes a line of code in the C programming language indicated as “EXEC SQL . . . ” which may represent a form of a line of code useable to call the database management program 304. In various embodiments, the user application 302 can be any of a variety of user applications useable to access and/or modify data in a database.

The database management program 304 can be any program implementing a database management system that is hosted by an underlying operating system. In an example embodiment, the database management program may correspond to a relational database management system, such as the relational database management system (RDMS) available from Unisys Corporation of Blue Bell, Pa. In alternative embodiments, other types of database management systems, and other arrangements of databases, could be used as well.

In the embodiment shown, the database management program 304 may include a syntax analyzer component 306, an access component 308, and an error status component 310. The components 306-310 may be used to access and validate access requests to data on behalf of the user application 302 by the database management program 304. The syntax analyzer component 306 may receive a database command from the user application 302, such as a SQL command, or other database command that will allow the application program to select, delete, insert, and update data in a database. In some embodiments, the syntax analyzer component 306 may determine an operation to be performed based on parsing of the received command.

If no errors are detected in the command, the access component 308 may interface with an underlying operating system to access a file containing data associated with the database accessed by the user application 302 for parsing and use by the database management program 304. The access component 308 can then execute the database command as defined in the received command. In such a case, an error status component 310 may be set to indicate that no error has occurred in completion of the database operation. However, if an error is detected in the syntax analyzer component 306, or during performance of the command by the access component 308, error status component 310 may indicate that an error exists in the received database command. Accordingly, either a confirmation of the properly executed database command, or an indication of an error, can be returned from the error status component 310 to the user application 302.

In some embodiments, beyond passage of particular database commands from the user application 302, it is also possible for the database management program 304 to allow use of placeholder variables in a command string, and therefore transfer values from program variables in the C code of the program to the database, or from the database to program variables in the C code, thereby integrating the database as a mechanism for storage of large program constructs, such as variables of large size, variable classes, and other data structures used as variables and for which storage in a database is convenient.

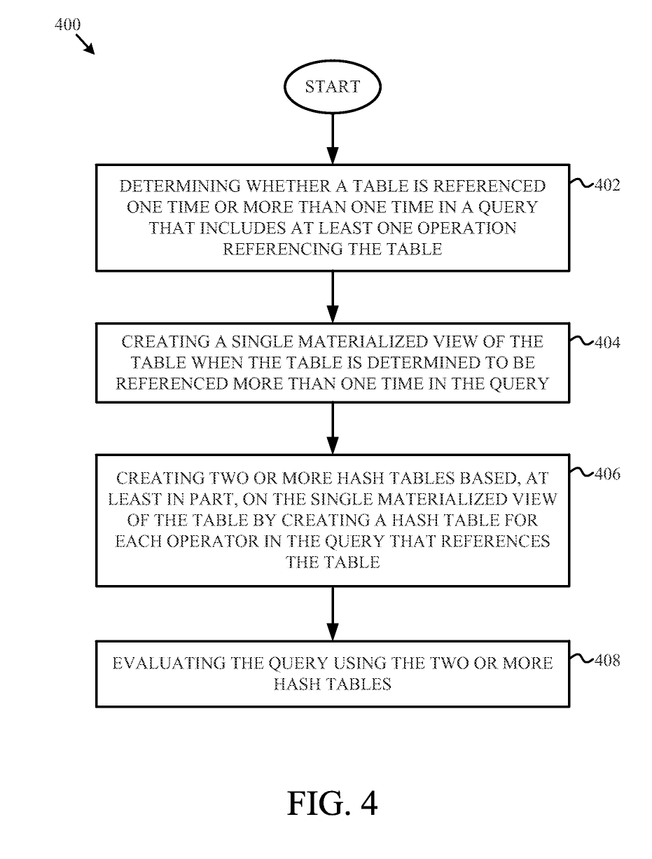

FIG. 4 illustrates a method 400 for processing tables for query operations referencing the tables according to one embodiment. Embodiments of method 400 may be implemented with the systems described with respect to FIGS. 1-3 and 6-8. Specifically, method 400 includes, at block 402, determining whether a table is referenced one time or more than one time in a query that includes at least one operation referencing the table. In some embodiments, a processor on which a database management system, such as database management systems 104, 204, or 304, executes may receive an analytic query to be evaluated as discussed with reference to block 402 to determine whether a table in the query is referenced one time or more than one time. In some embodiments, the determination performed at block 402 may be performed by an analytic query syntax analyzer function of a database management system, such as syntax analyzer component 306.

At block 404, a single materialized view of the table may be created when the database management system determines that the table is referenced more than one time in the query. In some embodiments, the tables referenced by the query that are to be materialized may be retrieved by the database management system from a database, such as database 108 or 208. For example, in one embodiment, a database access function of a database management system, such as access database component 308, may be used to retrieve the referenced tables. According to some embodiments, once the referenced table has been retrieved, an analytic query syntax analyzer function of the database management system, such as syntax analyzer component 306, may be used to create the single materialized view of the referenced table. According to another embodiment, a single materialized view of the table may also be created when a table referenced in a received query is not the first table referenced in an operation referencing the table, such as a JOIN operation. Therefore in some embodiments, a single materialized view may be created, such as at block 404, when either the database management system determines that the table is referenced more than one time in the query or when the table referenced in a received query is not the first table referenced in an operation referencing the table.

At block 406, two or more hash tables may be created based, at least in part, on the single materialized view of the table by creating a hash table for each operator in the query that references the table. For example, in one embodiment, an analytic query syntax analyzer function of the database management system, such as syntax analyzer component 306, may be used to create the two or more hash tables based on the single materialized view of the table. According to some embodiments, the hash tables may facilitate efficient access to relations during execution of a JOIN operation.

At block 408, the database management system may evaluate the query using the two or more hash tables. Therefore, rather than materializing the table multiple times, the database management system may materialize the table only once and then use hash tables created for the materialized table to subsequently evaluate the query that references the table.

In some embodiments, the processing by a database management system of tables for query operations referencing the tables may be further improved by constructing an instruction set to be used by a runtime processor component of the database management system to eliminate additional subsequent passes through a materialized derived table/CTE set of records. For example, an instruction set may be created which prevents creation of a subsequent materialized view of the table after the single materialized view has been created. According to some embodiments, the instruction set may be created based, at least in part, on the two or more hash tables and the single materialized view of the table. With the instruction set created, the database management system may evaluate the query using the instruction set, which may ensure that the materialized view of the referenced table only gets created once.

In some embodiments, the determination performed at block 402 may indicate that a received query is not referenced more than one time. When a table is determined to be referenced only one time in a received query, the database management system may evaluate the query using data within the table without creating a materialized view of the table. For example, according to one embodiment, the query may be evaluated using just-in-time compilation and evaluation schemes, in which data within the table is used for evaluation of the query but a materialized view of the table is not created. In some embodiments, evaluating the query without materializing a table referenced only once may reduce execution time and memory consumption, and therefore improve performance of the database management system, because the tuples (records) of the relation need not be stored and because a data structure to locate the tuples need not be created.

Although the disclosure thus far has primarily discussed operations on a single table, the functions/operations disclosed herein may be performed on multiple tables either in parallel or serially. One of skill in the art will appreciate that the same processing of a single table may applied to process multiple tables referenced in the query.

The schematic flow chart diagram of FIG. 4 is generally set forth as a logical flow chart diagram. As such, the depicted order and labeled steps are indicative of one aspect of the disclosed method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagram, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

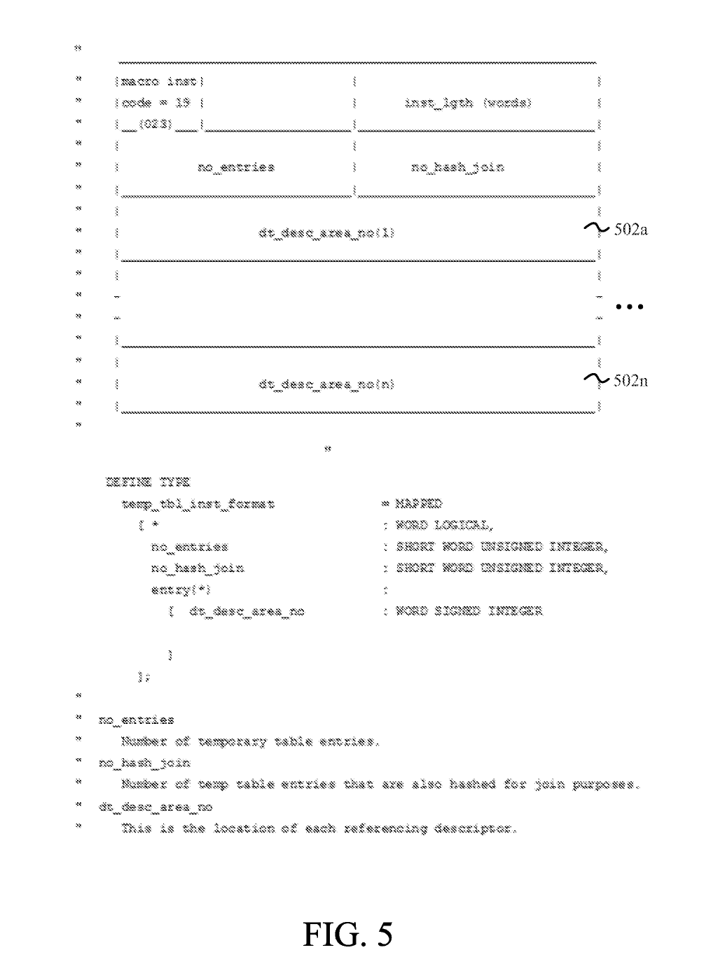

FIG. 5 provides an illustration of an instruction set invoked when a table, such as a derived table or CTE, is referenced and subsequently materialized. In some embodiments, the instruction set illustrated in FIG. 5 may correspond to a data structure compatible with the database management system, such as database management systems 104, 204, or 304, and may represent a temporary table instruction format. The format illustrated in FIG. 5 may be used for a table, such as a derived table or CTE, that is referenced more than once or which is not the first relation of a join operation. In some embodiments, the instruction set of FIG. 5 may be attached to a table definition when materialization of the table is necessary. Each reference to the table may be represented by a base descriptor, and each base descriptor may be assigned to an area number (no.) 502. According to some embodiments, the structure illustrated in FIG. 5 may contain a list of each referencing descriptor's area number 502. The list may be used to assign a temporary table control packet to each descriptor, and the assigned temporary table may be initialized with the location of the result set of the referenced table.

In some embodiments, when a referenced table participates in a hash join, a hash table may be created while populating the temporary table result set for the hash join. According to another embodiment, if the variable “no_hash_join” is non-zero, then there may exist one or more temporary table entries. If a temporary table entry exists, it may be located in the “dt_desc_area_no” array and may correspond to a descriptor that contains the hash instruction for the temporary table entry and is associated with the area number 502 within the “dt_desc_area_no” array in which the temporary table entry is located. According to another embodiment, the variable “no_entries” may indicate the size of the “dt_desc_area_no” array.

An example of a query including a derived table is provided below:

declare c cursor select code, veg from
(select order_no, veg from farmer.seed where order_no<10)
dt1(code, veggie), farmer.seed, cub.stores
where seed.veg=dt1.veggie and dt1.code=stores.product_code

In general, each FROM clause reference of a referenced table, such as a derived table or CTE, may be represented by a base descriptor and may contain a pointer to the definition of the referenced table and the operator/predicate that references the table. In some embodiments, the pointer may include the hash key for the referenced table if one was created, for example, by the syntax analyzer/optimizer 306. In the example provided above, the join predicate dt1.code=stores.product_code may use the join predicate to perform a primary key index search on table stores. In addition, in other embodiments, the definition of the referenced table may contain an instruction set, such as the instruction set illustrated in FIG. 5, to guide the processing of the query.

In the example query provided above, the select block contains three relations: dt1, farmer.seed, and cub.stores. In accordance with an embodiment of this disclosure, the execution of the above query may include materialization of each of the derived tables dt1, farmer.seed, and cub.stores. In one embodiment, a hash table with dt1.veggie may be created. According to some embodiments, each record of the derived table result set may be insert into a temporary table and each hash record may be insert into the dt1.veggie hash table.

Although this disclosure primarily describes embodiments in which the analytic query is a SQL database operation command, the embodiments of this disclosure are not limited to SQL. For example, the embodiments of this disclosure may also be applicable to the Hadoop NoSQL language Pig. In general, the embodiments of this disclosure may be applicable to various database command languages so long as they perform the functions as specified in the appended claims.

FIG. 6 illustrates a computer network 600 for processing tables for query operations referencing the tables in a computing system according to one embodiment of the disclosure. The system 600 may include a server 602, a data storage device 606, a network 608, and a user interface device 610. The server 602 may also be a hypervisor-based system executing one or more guest partitions hosting operating systems with modules having server configuration information. In a further embodiment, the system 600 may include a storage controller 604, or a storage server configured to manage data communications between the data storage device 606 and the server 602 or other components in communication with the network 608. In an alternative embodiment, the storage controller 604 may be coupled to the network 608.

In one embodiment, the user interface device 610 is referred to broadly and is intended to encompass a suitable processor-based device such as a desktop computer, a laptop computer, a personal digital assistant (PDA) or tablet computer, a smartphone or other mobile communication device having access to the network 608. In a further embodiment, the user interface device 610 may access the Internet or other wide area or local area network to access a web application or web service hosted by the server 602 and may provide a user interface for enabling a user to enter or receive information.

The network 608 may facilitate communications of data between the server 602 and the user interface device 610. The network 608 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate.

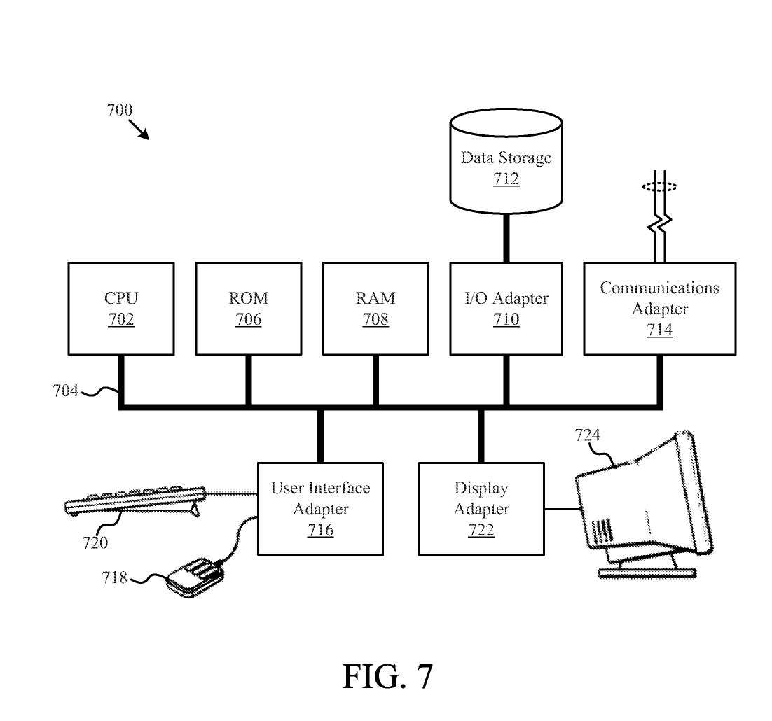

FIG. 7 illustrates a computer system 700 adapted according to certain embodiments of the server 602 and/or the user interface device 610. The central processing unit (“CPU”) 702 is coupled to the system bus 704. The CPU 702 may be a general purpose CPU or microprocessor, graphics processing unit (“GPU”), and/or microcontroller. The present embodiments are not restricted by the architecture of the CPU 702 so long as the CPU 702, whether directly or indirectly, supports the operations as described herein. The CPU 702 may execute the various logical instructions according to the present embodiments.

The computer system 700 may also include random access memory (RAM) 708, which may be synchronous RAM (SRAM), dynamic RAM (DRAM), synchronous dynamic RAM (SDRAM), or the like. The computer system 700 may utilize RAM 708 to store the various data structures used by a software application. The computer system 700 may also include read only memory (ROM) 706 which may be PROM, EPROM, EEPROM, optical storage, or the like. The ROM may store configuration information for booting the computer system 700. The RAM 708 and the ROM 706 hold user and system data, and both the RAM 708 and the ROM 706 may be randomly accessed.

The computer system 700 may also include an input/output (I/O) adapter 710, a communications adapter 714, a user interface adapter 716, and a display adapter 722. The I/O adapter 710 and/or the user interface adapter 716 may, in certain embodiments, enable a user to interact with the computer system 700. In a further embodiment, the display adapter 722 may display a graphical user interface (GUI) associated with a software or web-based application on a display device 724, such as a monitor or touch screen.

The I/O adapter 710 may couple one or more storage devices 712, such as one or more of a hard drive, a solid state storage device, a flash drive, a compact disc (CD) drive, a floppy disk drive, and a tape drive, to the computer system 700. According to one embodiment, the data storage 712 may be a separate server coupled to the computer system 700 through a network connection to the I/O adapter 710. The communications adapter 714 may be adapted to couple the computer system 700 to the network 608, which may be one or more of a LAN, WAN, and/or the Internet. The user interface adapter 716 couples user input devices, such as a keyboard 720, a pointing device 718, and/or a touch screen (not shown) to the computer system 700. The display adapter 722 may be driven by the CPU 702 to control the display on the display device 724. Any of the devices 702-722 may be physical and/or logical.

The applications of the present disclosure are not limited to the architecture of computer system 700. Rather the computer system 700 is provided as an example of one type of computing device that may be adapted to perform the functions of the server 602 and/or the user interface device 710. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 700 may be virtualized for access by multiple users and/or applications.

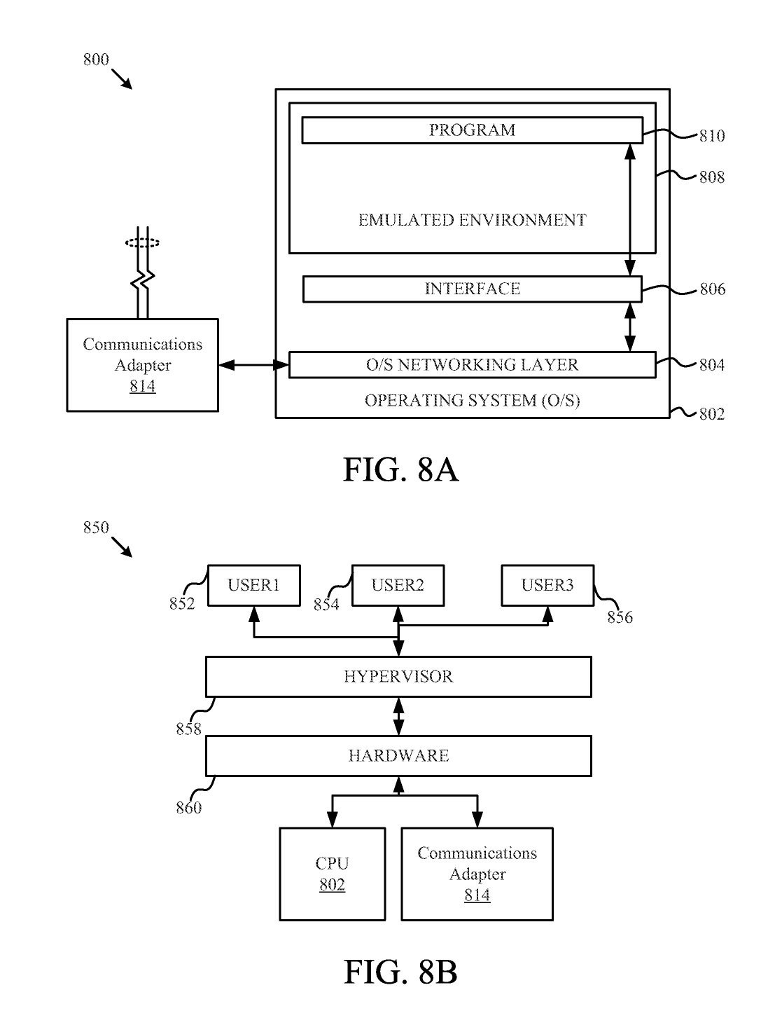

FIG. 8A is a block diagram illustrating a server hosting an emulated software environment for virtualization according to one embodiment of the disclosure. An operating system 802 executing on a server includes drivers for accessing hardware components, such as a networking layer 804 for accessing the communications adapter 814. The operating system 802 may be, for example, Linux or Windows. An emulated environment 808 in the operating system 802 executes a program 810, such as Communications Platform (CPComm) or Communications Platform for Open Systems (CPCommOS). The program 810 accesses the networking layer 804 of the operating system 802 through a non-emulated interface 806, such as extended network input output processor (XNIOP). The non-emulated interface 806 translates requests from the program 810 executing in the emulated environment 808 for the networking layer 804 of the operating system 802.

In another example, hardware in a computer system may be virtualized through a hypervisor. FIG. 8B is a block diagram illustrating a server hosting an emulated hardware environment according to one embodiment of the disclosure. Users 852, 854, 856 may access the hardware 860 through a hypervisor 858. The hypervisor 858 may be integrated with the hardware 860 to provide virtualization of the hardware 860 without an operating system, such as in the configuration illustrated in FIG. 8A. The hypervisor 858 may provide access to the hardware 860, including the CPU 802 and the communications adaptor 814.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media.

In addition to storage on computer-readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method for processing tables for query operations referencing the tables, comprising:
determining, with a processor, whether a table is referenced one time or more than one time in a query that includes at least one operation referencing the table;
creating, with the processor, a single materialized view of the table when the table is determined to be referenced more than one time in the query;
creating, with the processor, two or more hash tables based, at least in part, on the single materialized view of the table by creating a hash table for each operator in the query that references the table; and
evaluating, with the processor, the query using the two or more hash tables.

2. The method of claim 1, further comprising evaluating the query using data within the table without creating a materialized view of the table when the table is determined to be referenced only one time in the query.

3. The method of claim 2, wherein evaluating the query using data within the table without creating a materialized view of the table comprises evaluating the query using just-in-time compilation and evaluation.

4. The method of claim 1, further comprising creating an instruction set which prevents creation of a subsequent materialized view of the table after the single materialized view has been created, wherein the instruction set is created based, at least in part, on the two or more hash tables and the single materialized view of the table.

5. The method of claim 4, further comprising evaluating the query using the instruction set.

6. The method of claim 1, further comprising creating the single materialized view of the table when the table is not a first table referenced in the operation referencing the table.

7. A computer program product, comprising:
a non-transitory computer-readable medium comprising instructions which, when executed by a processor of a computing system, cause the processor to perform the steps of:
determining whether a table is referenced one time or more than one time in a query that includes at least one operation referencing the table;
creating a single materialized view of the table when the table is determined to be referenced more than one time in the query;
creating two or more hash tables based, at least in part, on the single materialized view of the table by creating a hash table for each operator in the query that references the table; and
evaluating the query using the two or more hash tables.

8. The computer program product of claim 7, wherein the medium further comprises instructions to cause the processor to perform the step of evaluating the query using data within the table without creating a materialized view of the table when the table is determined to be referenced only one time in the query.

9. The computer program product of claim 8, wherein evaluating the query using data within the table without creating a materialized view of the table comprises evaluating the query using just-in-time compilation and evaluation.

10. The computer program product of claim 7, wherein the medium further comprises instructions to cause the processor to perform the step of creating an instruction set which prevents creation of a subsequent materialized view of the table after the single materialized view has been created, wherein the instruction set is created based, at least in part, on the two or more hash tables and the single materialized view of the table.

11. The computer program product of claim 10, wherein the medium further comprises instructions to cause the processor to perform the step of evaluating the query using the instruction set.

12. The computer program product of claim 7, wherein the medium further comprises instructions to cause the processor to perform the step of creating the single materialized view of the table when the table is not a first table referenced in the operation referencing the table.

13. An apparatus, comprising:
a memory; and
a processor coupled to the memory, the processor configured to execute the steps of:
determining whether a table is referenced one time or more than one time in a query that includes at least one operation referencing the table;
creating a single materialized view of the table when the table is determined to be referenced more than one time in the query;
creating two or more hash tables based, at least in part, on the single materialized view of the table by creating a hash table for each operator in the query that references the table; and
evaluating the query using the two or more hash tables.

14. The apparatus of claim 13, wherein the processor is further configured to perform the step of evaluating the query using data within the table without creating a materialized view of the table when the table is determined to be referenced only one time in the query.

15. The apparatus of claim 14, wherein evaluating the query using data within the table without creating a materialized view of the table comprises evaluating the query using just-in-time compilation and evaluation.

16. The apparatus of claim 13, wherein the processor is further configured to perform the step of creating an instruction set which prevents creation of a subsequent materialized view of the table after the single materialized view has been created, wherein the instruction set is created based, at least in part, on the two or more hash tables and the single materialized view of the table.

17. The apparatus of claim 16, wherein the processor is further configured to perform the step of evaluating the query using the instruction set.

18. The apparatus of claim 13, wherein the processor is further configured to perform the step of creating the single materialized view of the table when the table is not a first table referenced in the operation referencing the table.
